(19) United States
(12) Patent Application Publication
(10) Pub. No.: US 2013/0004911 A1
(43) Pub. Date: Jan. 3, 2013

(54) METHOD AND APPARATUS FOR FORMING ORTHODONTIC BRACKETS

(76) Inventor: Atsushi DANNO, Singapore (SG)

(21) Appl. No.: 13/339,354

(22) Filed: Dec. 28, 2011

(30) Foreign Application Priority Data
Dec. 29, 2010 (SG) 201009753-3

(51) Int. Cl. A61C 7/28; B21K 23/00; B21D 22/02; B23P 13/00

(52) U.S. Cl. 433/10; 29/896.11; 72/352; 72/462

(57) ABSTRACT

Proposed is a method and apparatus for forming an orthodontic bracket for use with an orthodontic archwire involving shaping a length of material to form at least two enlarged portions and a base member, the base member being intermediate two arm members and the respective enlarged portions having a thickness that is thicker than the thickness of the base member; bending the length of material at the respective enlarged portions; and coining the respective enlarged portions, such that portions of the arm members define a channel to receive a portion of the orthodontic archwire.

### FIELD AND BACKGROUND

The present disclosure relates to a method and apparatus for forming orthodontic brackets.

For people suffering from dental conditions involving flaws of the teeth and jaw, such as crooked teeth or malocclusions, the path to a perfectly aligned set of teeth would typically mean having to wear orthodontic braces, otherwise commonly known as dental braces, over a period of time to correct those conditions.

Wearing dental braces involve fixing orthodontic brackets (conventional or self-ligating type) as attachments onto surfaces of the teeth using dental cement, to facilitate exertion of forces through the brackets using orthodontic archwires and/or other auxiliaries to gradually move the teeth into their desired positions. An example of a self-ligating bracket is described in WO 2005/044131. However, there has not been an economic method of making such orthodontic brackets.

It is an object to provide a method of forming orthodontic brackets which addresses at least one of the problems of the prior art and/or to provide the public with a useful choice.

### SUMMARY

Proposed herein is a first embodiment providing a method of forming an orthodontic bracket for use with an orthodontic archwire, the method comprising: shaping a length of material to form at least two enlarged portions and a base member, the base member being intermediate two arm members and the respective enlarged portions having a thickness that is thicker than the thickness of the base member; bending the length of material at the respective enlarged portions; and coining the respective enlarged portions, such that portions of the arm members define a channel to receive a portion of the orthodontic archwire.

An advantage of using the described method to form the bracket is that the enlarged portions are shaped to much thicker than the base member. so that during the bending stage and after when the enlarged portions are compressed by coining, the risk of the portions suffering from cracking is much reduced. In this way, this also makes it simpler and more economic to form orthodontic brackets of any type.

Preferably, each of the enlarged portions may be bent and coined to form a corner radius that is smaller than three times the thickness of the base member. Further, the coining may be performed after the completion of the bending. Optionally, the coining may be performed towards the completion of the bending.

More preferably, the shaping step may comprise metal stamping and cold forging the material. In addition, the portions of the arm members defining the channel may be configured to resiliently cooperate with each other for receiving the portion of the orthodontic archwire. Yet further, the arm members may preferably be configured to permit an elastic band to be releasably secured around the arm members for restraining the portion of the orthodontic archwire.

Yet preferably, the method may further comprise forming at least one locating feature on the base member to locate the portion of the orthodontic archwire. Moreover, the material may have a modulus of elasticity in a range of between 40 to 60 GigaPascals (GPa), which is significantly lower than those of conventional steels, and the material may be selected from the group consisting of a titanium-based alloy and a stainless steel.

Also disclosed is a second embodiment providing an orthodontic bracket formed by the method taught in the first aspect. Preferably, the orthodontic bracket may be self-ligating or non-self-ligating.

Also proposed is a third embodiment providing an apparatus for forming an orthodontic bracket for use with an orthodontic archwire, the apparatus comprising: means for shaping a length of material to form at least two enlarged portions and a base member, the base member being intermediate two arm members and the respective enlarged portions having a thickness that is thicker than the thickness of the base member; means for bending and coining the length of material at the respective enlarged portions, such that portions of the arm members define a channel to receive a portion of the orthodontic archwire.

Preferably, the means for bending and coining may be configured to form a corner radius at each of the enlarged portions, the corner radius being smaller than three times the thickness of the base member. Further, the means for bending and coining may be configured such that the coining is performed after the bending. Alternatively, the means for bending and coining may be configured such that the coining is performed towards the end of the bending. In addition, the means for shaping may preferably comprise means for metal stamping and cold forging. Yet more preferably, the apparatus may include a Multi-slide Forming (MSF) machine being cooperatively operated with a Computer Numerical Control (CNC) machine.

These and other embodiments will be apparent from and elucidated with reference to the embodiments described hereinafter.

### BRIEF DESCRIPTION OF THE DRAWINGS

An exemplary embodiment will now be described with reference to the accompanying drawings, in which:

FIG. 1 schematically illustrates a method for forming an orthodontic self-ligating bracket according to an embodiment;

FIG. 2, comprising FIGS. 2A to 2H, depicts various stages of forming the orthodontic self-ligating bracket based on the method of FIG. 1;

so FIG. 3, comprising FIGS. 3A to 3C, illustrates a technique for bending a metal piece having an enlarged portion, this technique being used in the method of FIG. 1 for forming the orthodontic self-ligating bracket;

FIG. 4A includes a first photograph illustrating the metal piece of FIG. 3 placed next to a measuring scale and a second photograph illustrating a magnified view of the metal piece of FIG. 3;

FIG. 4B shows photographs illustrating various perspective views of the workpiece of FIG. 4A after being bent at the enlarged portion according to the technique of FIG. 3;

FIG. 5 shows a strain analysis diagram performed using Finite Element Method (FEM) on the bent portion of the metal piece of FIG. 4B;

FIG. 6 shows an elevation view of the orthodontic self-ligating bracket, formed using the method of FIG. 1, having an orthodontic archwire received therein;

FIG. 7, comprising 7A to 7C, shows the use of a Multi-slide Forming Machine for performing the method of FIG. 1;

FIG. 8 shows an elevation view of a different type of self-ligating orthodontic bracket that may be formed using the method of FIG. 1; and

FIG. 9 shows an elevation view of a non-self-ligating orthodontic bracket that may be formed using the method of FIG. 1.

### DETAILED DESCRIPTION

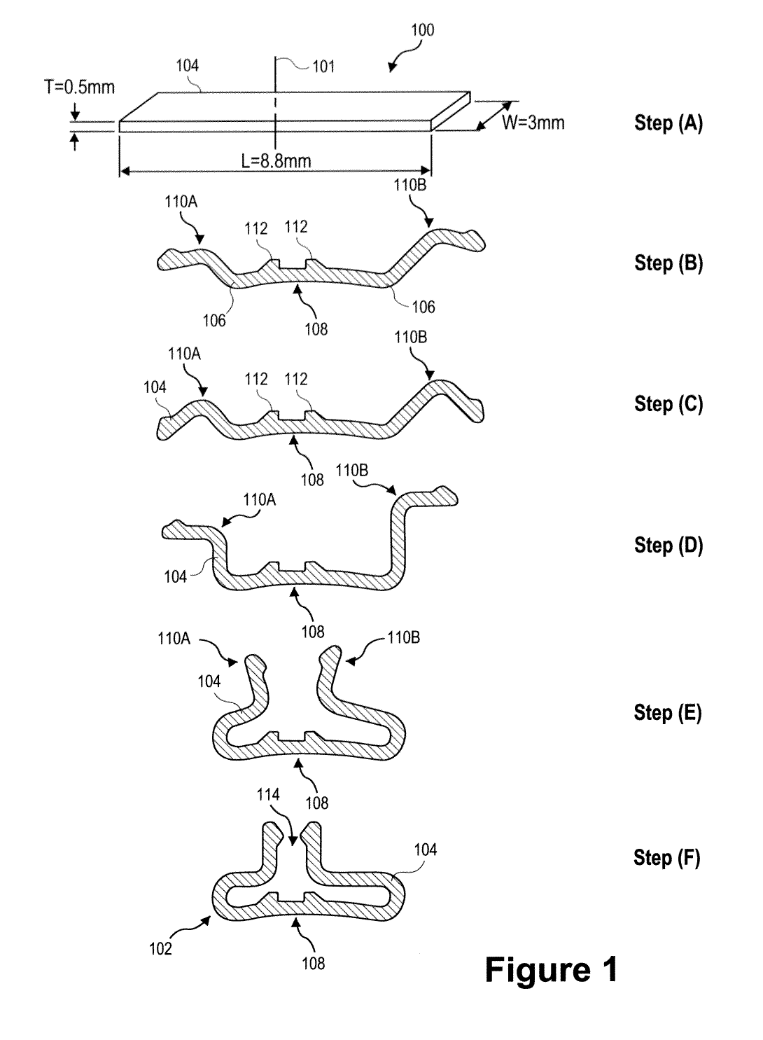

FIG. 1 shows a method 100, depicting Steps (A) to (F), for forming an orthodontic bracket 102 (hereinafter orthodontic bracket) from a length of material such as a workpiece 104 according to a first embodiment of the method. In this exemplary embodiment, the orthodontic bracket 102 is of the self-ligating type and the workpiece 104 is composed of beta (β) titanium alloy, Ti59-Nb36-so Ta2-Zr2-O which is nickel-free and characterised by low Young's modulus as well as high tensile strength. In particular, Ti59-Nb36-Ta2-Zr2-O displays a Young's modulus that ranges between 40 to 60 GigaPascal (GPa), which is significantly lower than those of conventional steels, which are approximately in the region of 200 GPa.

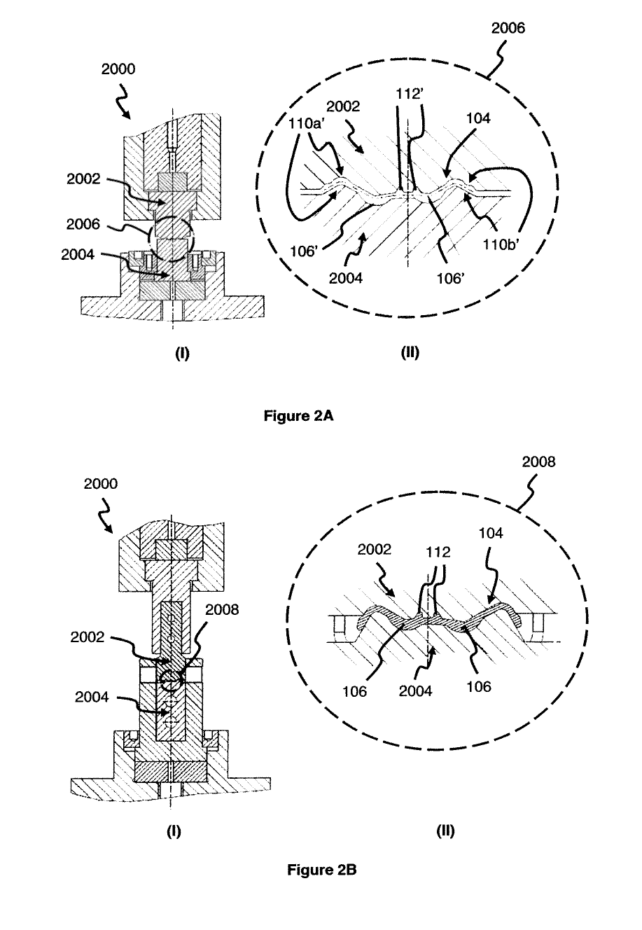

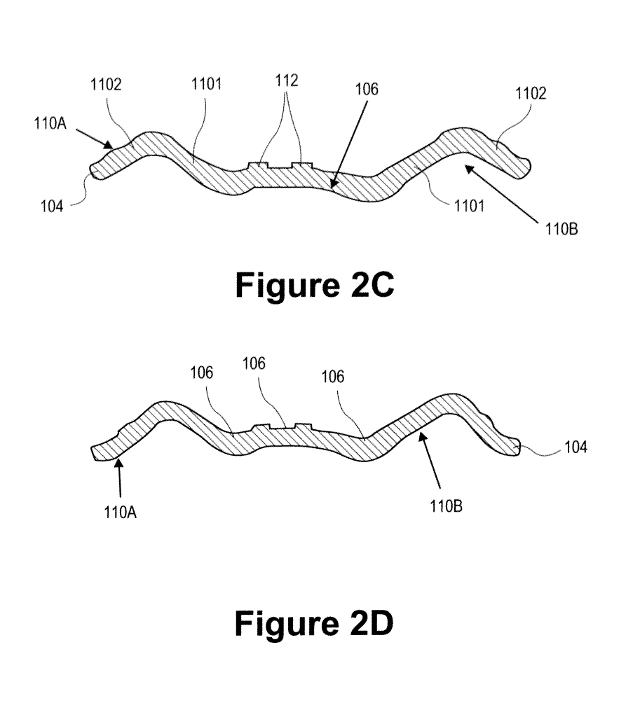

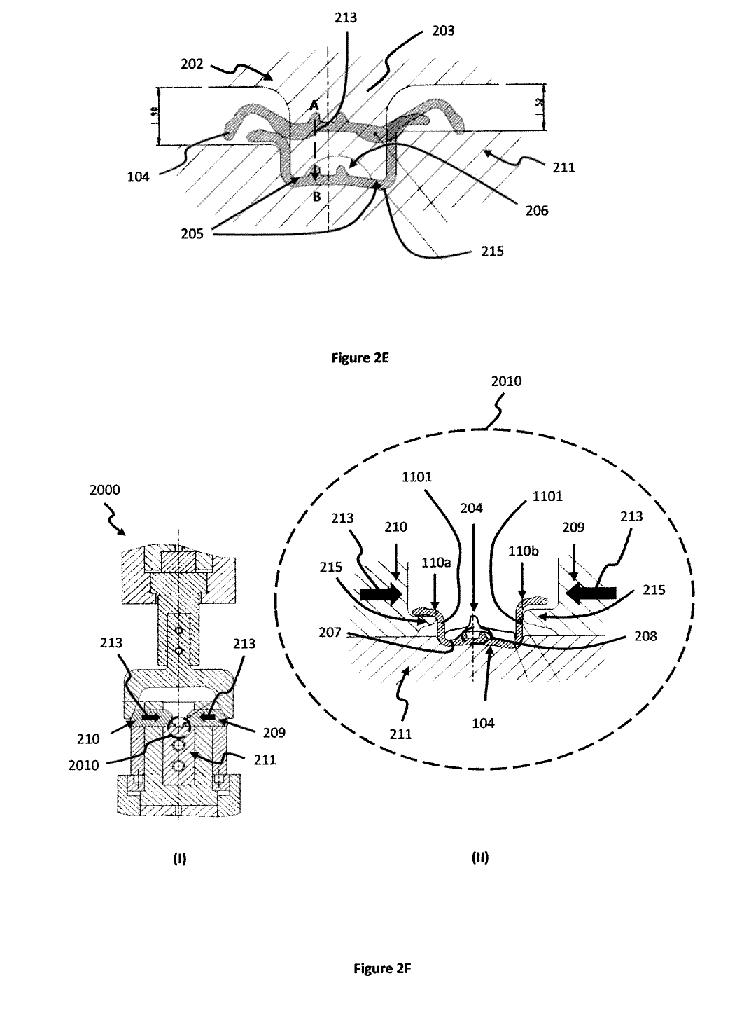

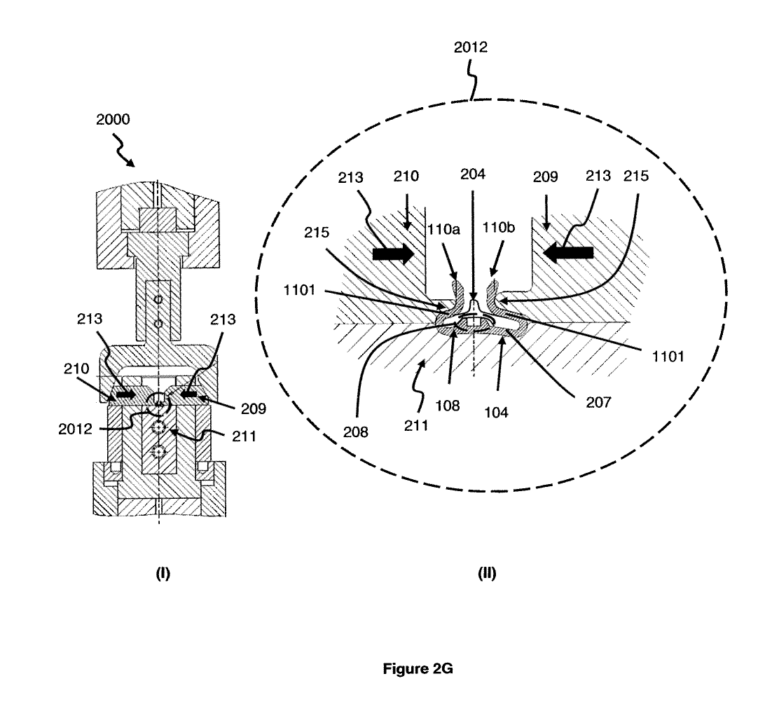

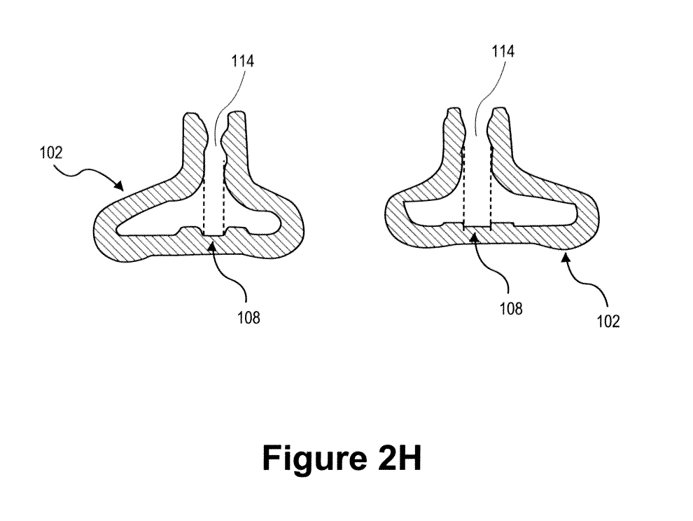

For ease of describing the embodiment, the method 100 will be described together with FIGS. 2A to 2H, which depict various stages of processing the workpiece 104 based on the method 100 of FIG. 1 to form the orthodontic bracket 102. In the drawings and description, like parts are denoted by like reference numerals.

At Step (A) of the method 100, the workpiece 104 is illustrated as a length of titanium alloy with substantially uniform thickness. In this embodiment, the length, thickness and width of the workpiece 104 are 8.8, 0.5 and 3 millimetres respectively.

From Step (A) to a following Step (B), the workpiece 104 is subjected to a combination of metal stamping and cold forging to shape the workpiece 104 to form desired thickness distributions along the length of the workpiece 104 on each side of a centre of the workpiece, which intersects with an imaginary centre line 101 shown in Step (A). While the thickness along the length of each side of the workpiece 104 is shaped to vary, the thickness distribution on both sides are in fact arranged to be substantially symmetrical, such that the orthodontic bracket 102 when eventually formed is also substantially symmetrical about the imaginary centre line 101.

Now, in conjunction with FIGS. 2A (I) and 2B (I), a tooling apparatus 2000 which comprises a punch 2002 (i.e. upper tool) and a die 2004 (i.e. lower tool), is configured for the purpose of shaping the workpiece 104. It will be appreciated that the punch 2002 and die 2004 are in a generally reciprocating arrangement relative to each other. In addition, FIGS. 2A (II) and 2B (II) are magnified views of the respective sections 2006, 2008 marked out (via circular dotted lines) on the tooling apparatus 2000 of FIGS. 2A (I) and 2B (I) to illustrate the punch 2002 and die 2004 in greater detail. First, the punch 2002 and die 2004 are each pre-moulded (using any known moulding techniques) to have the necessary desired features, and thereafter operably fitted onto the tooling apparatus 2000.

Specifically, the punch 2002 includes a first set of features shaped as a pair of teeth members 112′, and two lengthened portions 110a′, 110b′, each extending from each of the teeth members 112′ in opposing directions. On the other hand, the die 2004 includes a second set of features shaped as a pair of bumps 106′, and two lengthened portions 110a′, 110b′. each extending from each of the bumps 106′ in opposing directions. It is to be further appreciated that the positioning of the teeth members 112′ overlaps with the gap separating the bumps 106′, when the punch 2002 is reciprocated to the die 2004.

Considerations taken into account for forming the type/dimensions of the first and second sets of features include analysis results from Finite Element Method (FEM) simulations conducted on the basis to determine what should the desired thickness of the bumps 106 be after they are bent (i.e. the initial thickness should be sufficiently thick to compensate for the thickness reduction incurred as a result of being bent). Therefore, when the punch 2002 is reciprocated to the die 2004 in the arrangement as shown in FIG. 2A (II), an internal volume is defined in a space separating the punch 2002 and die 2004. More particularly, the internal volume is advantageously arranged to accommodate the workpiece 104 for forming (by metal stamping and cold forging using the punch 2002 and die 2004) on the workpiece 104, two bumps 106 from the bumps 106′ feature, a pair of teeth members 112 (also known as a locating feature) from the teeth members 112′ feature, and first and second arm members 110a, 110b (each extending from the respective bumps 106) from the lengthened portions 110a′, 110b′.

With the punch 2002 and die 2004 initially arranged in a spaced apart, non-engaging configuration, the workpiece 104 is then positioned on the die 2004 as shown in FIG. 2A (II), before being worked on by the tooling apparatus 2000. In that respect, the punch 2002 is operably urged towards the die 2004, such that it eventually abuts the workpiece 104, which is resting on the die 2004. At this stage, the workpiece 104 is interposed between the punch 2002 and die 2004 as shown in FIG. 2B (II). When that happens, the workpiece 104 is consequently shaped along its length, in conformance with the first and second sets of features formed on the punch 2002 and die 2004, which is clearly visible from FIG. 2B.

An associated photograph of the workpiece 104 at this stage corresponding to Step (B) is shown in FIG. 2C. Specifically, the workpiece 104 is shaped to form a base member 108 intermediate the two bumps 106, and the first and second arm members 110a, 110b. each extending from respective bumps 106 and are slightly bent relative to the base member 108. In other words, the separating distance between the bumps 106 defines the length of the base member 108 and each bump 106 is shaped to be thicker than the thickness of the base member 108. Accordingly in this embodiment, the base member 108 is 0.3 millimetre thick, while each bump 106 is arranged to be 0.1 millimetre thicker relatively. Moreover, the bumps 106 are configured to be the thickest portions along the entire workpiece 104.

As shown at step (B) of FIG. 1, each of the first and second arm members 110a, 110b are bent relative to the base member 108 and are also angled to form first and second sub-portions 1101,1102, which together define an acute angle between each other, as shown in FIG. 2C.

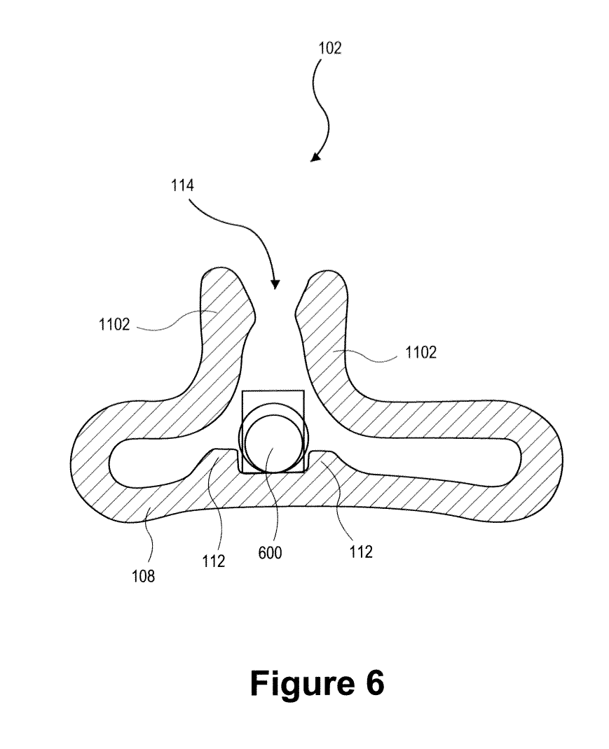

During the shaping carried out at Step (B), the pair of teeth members 112 is also formed on the base member 108 and projects upwards in the same general orientation as the arm members 110a, 110b. The pair of teeth members 112 is spaced-apart from each other corresponding to a predefined separating distance. In this instance, each teeth member 112 is a protrusion with flat surface, and their purpose is to co-operatively hold a suitable orthodontic archwire 600 (see FIG. 6) in place within the orthodontic bracket 102 after being received therein. This functionality will be elaborated in later passages.

At a next Step (C) of the method 100, the workpiece 104 undergoes further shaping. Specifically, the angled portions of each arm member 110a, 110b are bent further to facilitate ease of forming the orthodontic bracket 102, such that the first and second sub-portions 1101, 1102 now form a substantially right-angled joint. An associated photograph of the workpiece 104 at this stage is shown in FIG. 2D. The reason why further bending is carried out in this step is due to difficulties that might be encountered if it is being done at later steps since the type of tooling motion/direction applied to the method 100 of FIG. 1 can only be effected vertically or horizontally (as will be elaborated in passages below). Particularly, this means that at steps subsequent to Step (C), the and second sub-portions 1101, 1102 are awkwardly arranged out of position relative to the type of tooling motion usable on them, and therefore does not easily permit them to be bent in the appropriate manner as desired if the bending is performed later.

In this embodiment, Steps (B) and (C) may collectively be known as the “Pre-forming” stages.

At a further Step (D), the workpiece 104 is shaped such that from a front elevation view, the workpiece 104 resembles generally a U-shaped member defined by the base member 108, and the first and second arm members 110a, 110b. In particular, coining is used to conform the workpiece 104 after Step (C), to the U-shape.

In explaining the coining process, there is provided a bending/coining punch 202 having a press block 203 with a contact face 205 and a hemispherical recess 206 formed on the contact face 205 to accommodate the teeth members 112 as shown in FIG. 2E. In this way, when the contact face 205 of the punch 202 contacts the workpiece 104, the teeth members 112 are received in the hemispherical recess 206 to ensure that the teeth members 112 are not flattened during the coining process. In addition, a die 211 is provided, on which the workpiece 104 initially rests as supported via the bumps 106, as shown in a position indicated by “A”. At this position “A”, the workpiece 104 still corresponds to the state shown in FIG. 2D, and the punch 202 does not yet engage the workpiece 104. For sake of clarity, it will be appreciated that the punch 202 and die 211 used in this instance replace those (i.e. the punch 2002 and die 2004) previously used on the tooling apparatus 2000, shown in FIGS. 2A and 2B. Specifically, the punch 202 and die 211 presently fitted on the tooling apparatus 2000 are used for the purpose of bending and coining, whereas those in FIGS. 2A and 2B are for stamping and cold forging the workpiece 104.

When the punch 202 is subsequently driven to engage the workpiece 104, the punch 202 is actuated towards (i.e. downwardly in a vertical axial direction) the workpiece 104 to sit the workpiece 104 completely into the die 211. This repositions the workpiece 104 from the original position “A” to a new position “B” as indicated by a dotted arrow 213 When the workpiece 104 fits into the die 211 (in the position “B”), the two arm members 110a, 110b are inevitably bent inward during the process, as they are engaged by the side walls of the die 211, so that the first sub-portion 1101 of each arm member 110a, 110b becomes substantially planar to each other. This forms the U-shaped member depicted in Step (D).

With the bending of the arm members 110a, 110b, a coining process is performed on the workpiece 104 in the position “B” when the workpiece 104 abuts the bottom face 215 of the die 211. The effect of this is when the contact face 205 of the punch 202 compresses the bumps 106 against the bottom face 215 of the die 211, the extra thickness of each bump 106 is evenly re-distributed around its surrounding portions, resulting in a substantially uniform thickness being achieved around each bump 106. Notably, coining accordingly reduces the spring-back effect that might otherwise be imparted by the two bent arm members 110a, 110b.

In Step (E), the punch 202 in FIG. 2E is detached from the tooling apparatus 2000 and replaced by a mandrel tool 204 as shown in FIG. 2F (II), which is a magnified view of a section 2010 marked out (via a circular dotted line) on the re-fitted tooling apparatus 2000 as depicted in FIG. 2F (I). Particularly, it clearly illustrates that the mandrel tool 204 is positioned within the U-shaped workpiece 104 in an arrangement abutting the base member 108. The mandrel tool 204 is substantially flat and includes an engagement surface 207 having a trapezoidal recess 208 to allow the teeth members 112 to be received within the recess 208. Moreover, the mandrel tool 204 also has a much smaller profile than the punch 202 of FIG. 2E. Additionally, along with the mentioned mandrel tool 204, coplanar-positioned right and left side punches 209, 210 are also included in the setup of the tooling apparatus 2000. The right and left side punches 209, 210 are each specially formed with a protrusion portion 215 that is arranged to abut externally the first sub-portions 1101 of each arm member 110a, 110b of the U-shaped workpiece 104 as depicted in FIG. 2F (II). It is to be noted that the right and left side punches 209, 210 are independently movable towards each other in an inwardly horizontal direction as indicated by arrows 213.

From the position in FIG. 2F (II), the U-shaped workpiece 104 is operated on by the tooling apparatus 2000 as illustrated in FIG. 2G (II), whereby the right and left side punches 209, 210 are moved inwardly towards each other (in the direction of the arrows 213) to engage and rotate the two arm members 110a, 110b about the respective bumps 106 (i.e. effecting bending). FIG. 2G (II) is a magnified view of a section 2012 marked out (via a circular dotted line) on the tooling apparatus 2000 shown in FIG. 2G (I). In particular, the first sub-portions 1101 undergo an angular rotation of approximately 90° about the respective bumps 106 so that they now lie substantially parallel to the base member 108. The mandrel tool 204 positioned within the U-shaped workpiece 104 ensures that an internal volume of the workpiece 104 occupied by the mandrel tool 204 does not collapse and thereafter conforms to the shape outlined by the mandrel tool 204 after the arm members 110a, 110b are bent. Simultaneously, the bumps 106 undergo more coining in that they are further compressed by the inwardly moving side punches 209, 210 which then engage the first sub-portions 1101 and consequently press down on the bumps 106 through the mandrel tool 204 (which lies below and in contact with the first sub-portions 1101). The mandrel tool 204 is then removed thereafter, and the orthodontic bracket 102 formed is schematically shown in FIG. 2H.

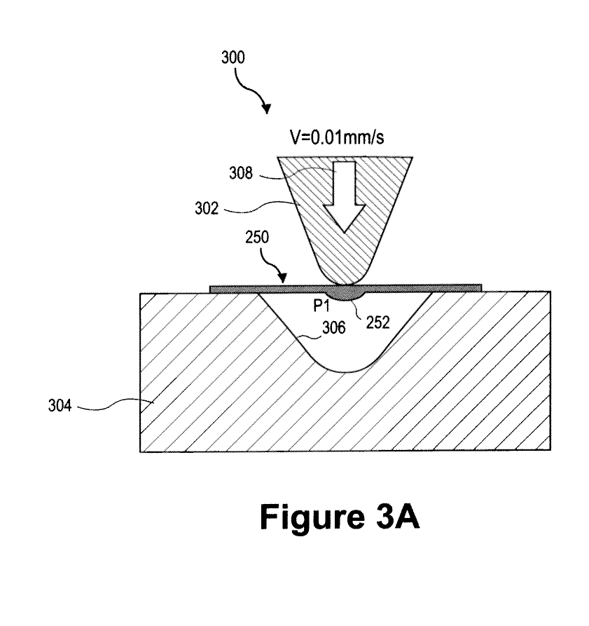

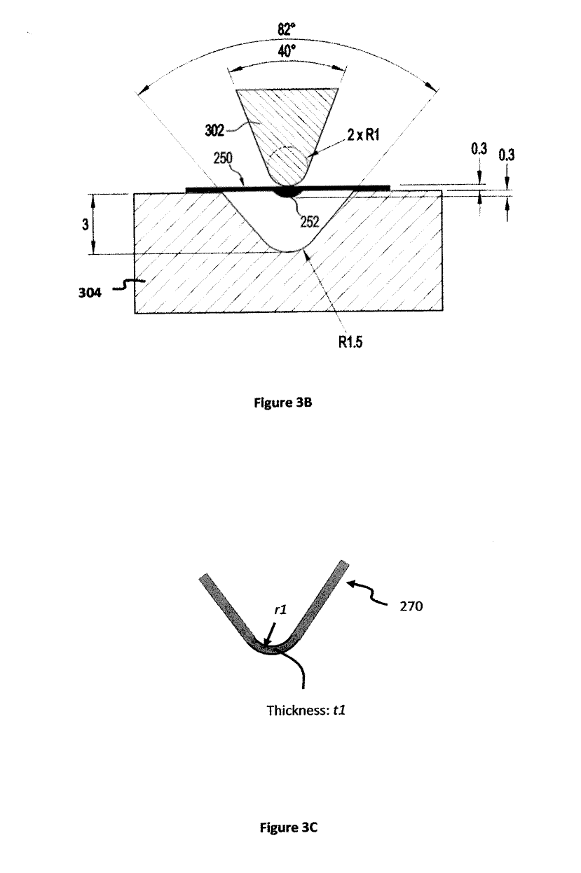

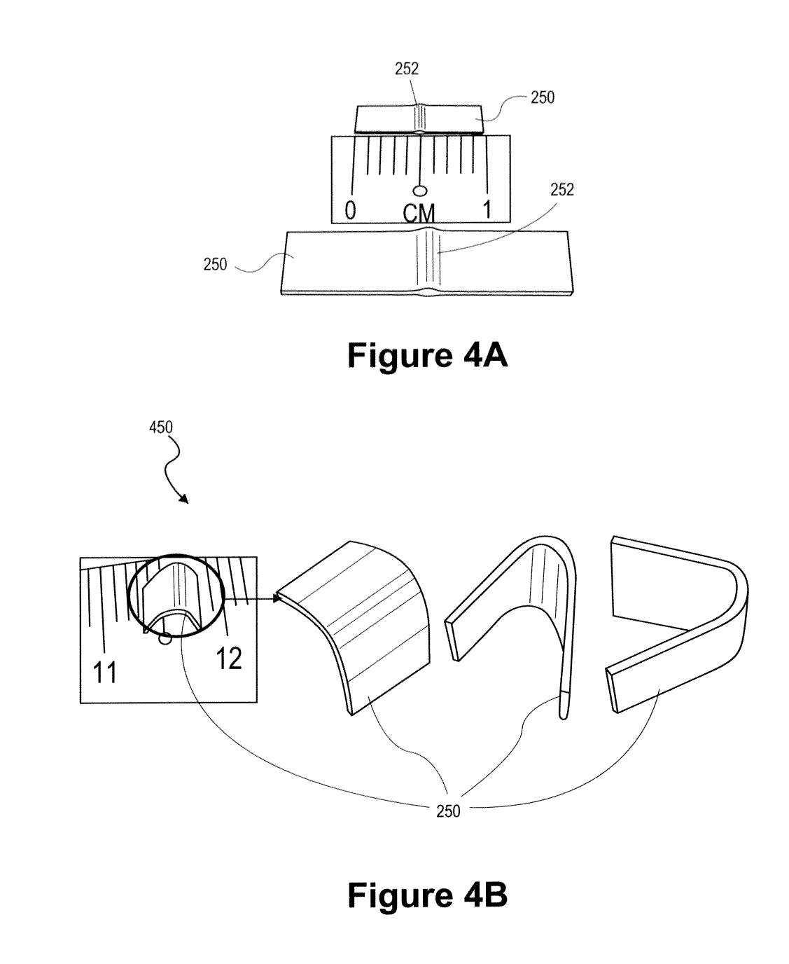

It would be helpful to further elaborate on the coining process by referring to FIGS. 3A and 3B which depict how a metal piece 250 is bent using coining and bending, similar to the way the first and second arm members 110a, 110b of the workpiece 104 are bent in accordance with Steps (D) and (E) of the method 100. Prior to the coining and bending process, the metal piece 250 is shaped to create an enlarged portion 252 which is thicker than the rest of the metal piece so 250. Please see FIG. 4A for a first photograph of the metal piece 250 and the enlarged portion 252 placed against a measuring tape (or rule) to illustrate the length of the metal piece 250, and a second photograph which is a magnified photo of the metal piece 250. The enlarged portion 252 is similar to the bump 106 illustrated in FIGS. 1 and 2.

The metal piece 250 is arranged between a punch 302 and a die 304 with the punch 302 positioned above the metal piece 250 and the die 304 supporting the metal piece 250. It should be appreciated that the punch 302 and die 304 of the existing arrangement is similar to the effects expressed by the punch 2002 and die 2004 of FIGS. 2A (I) and 2B (I). The punch 302 includes a wedged shaped body with a rounded top configured to facilitate in defining the bent of the metal piece 250. The die 304 includes a V-shaped groove 306, which helps to shape the bent of the metal piece 250.

To bend the metal piece 250, it is placed on a platform of the die 304, with the enlarged portion 252 aligned to the apex of the punch 302 and above the centre of the depression 306. Next, the punch 302 is actuated towards the metal piece 250 in a direction, as indicated by an arrow 308, to abut against the enlarged portion 252 and push the metal piece 250 at the enlarged portion 252 into the groove 306 until the metal piece 250 sits completely in the groove 306. The pressure asserted by the punch 302 against the metal piece 250 and die 304 compresses the enlarged portion 252 along the dimension of its thickness and thus reduces the thickness of the enlarged portion 252, while at the same time, bends the metal piece 250, with the degree of curvature at the bent portion being dependent on the width and depth of the V-shaped outline of the groove 306 and the wedge angle of the punch 302.

In this example as shown in FIG. 3B, the groove 306 has an internal angle defined to be approximately 82°, while the wedge angle of the punch 302 is configured to be smaller than that, arranged at approximately 40°. Further to that, the corner radius (labelled as “R1”) of the punch 302 is selected to be smaller than three times the thickness of the metal piece 250, and the fillet radius (labelled as “R1.5”) of the die 304 is selected to be greater than the sum of the corner radius and thickness of the metal piece 250. In this instance, the specific relevant dimensions of the corner radius, fillet radius and thickness of the workpiece 250 are respectively selected either as 0.5, 1.5, 0.3 millimetres or 1, 1.5, and 0.3 millimetres. It is to be appreciated that the corner radius “R1” of the punch 302 used is defined with reference to the bent corner of the metal piece 250. In other words, the corner radius of the punch 302 is (usually) of the same geometric dimension as the bent corner of the metal piece 250.

Therefore, this bending and coining process is particularly advantageous and effective for forming sharp bends on any metal workpiece 270 (see FIG. 3C), in which the corner radii (“r1”) of the bends may be approximately less than three times the thickness (“t1”) of the metal workpiece 270, to prevent thinning and cracking. In comparison, with respect to conventional V-bending techniques for forming sharp bends, in order to avoid thinning and cracking on the sharp bends during their formation, the requirement is that the corner radius (“r1”) of each bend must be three times greater than the thickness (“t1”) of the metal workpiece 270. Indeed, without limitations of the prior art, this bending and to coining process according to the method 100 is therefore suitable for forming bends on the metal workpiece 270 regardless whether the corner radius of each bend is three times greater or less than the thickness of the metal workpiece 270.

It should be further appreciated that since the enlarged portion 252 is initially pre-formed to be thicker than the other sections, when the metal piece 250 is bent at the enlarged portion 252, the area of bending deformation does not concentrate at the enlarged portion 252 but is instead spread around to other portions beside the enlarged portion 252 of the metal piece 250. Therefore, the eventual thickness of the metal piece 250 at the enlarged portion 252 after bending may not be thinner than the thickness of the other sections of the metal piece. In this way, the enlarged portion 252 is less susceptible to cracking during the bending operation.

FIG. 4B includes a number of photographs 450 of the bent metal piece 250 with one photograph showing the bent metal piece 250 placed against a measuring tape or rule to illustrate the size of the bent metal piece 250. FIG. 4B also includes three magnified photographs showing different views of the bent metal piece 250 from different angles. It will be appreciated that thinning and cracking of material at the bent corner during the performance of coining and bending is mitigated by virtue of forming the enlarged portion 252 in the metal piece 250.

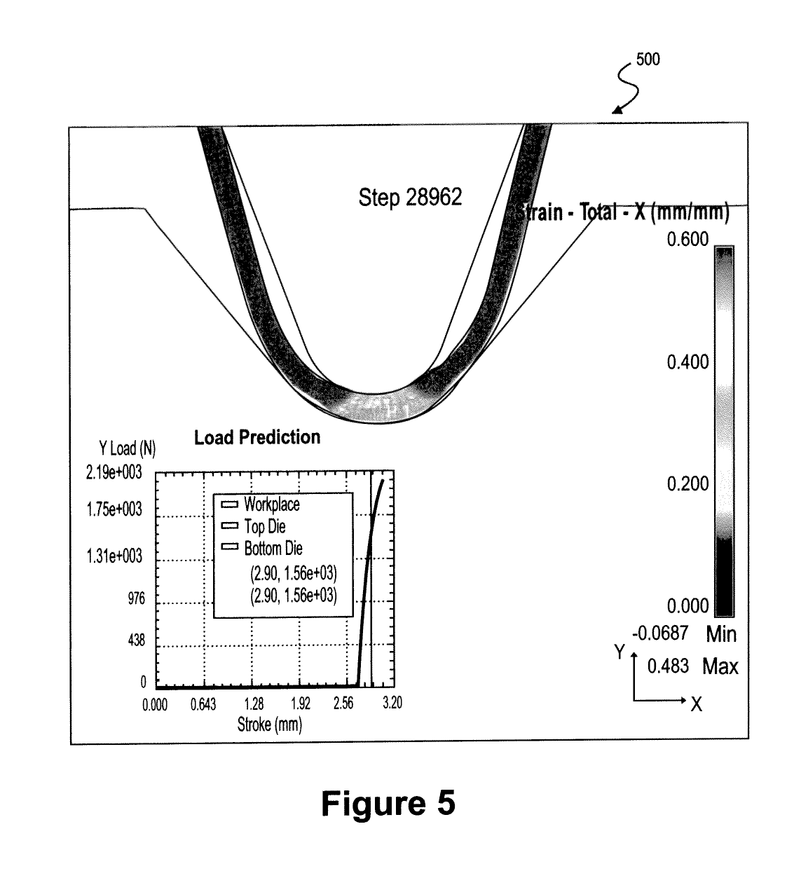

FIG. 5 illustrates a strain analysis 500 conducted on the metal piece 250 of FIG. 4B, specifically focusing on measurement of the strain distribution at the portion around the bent bump 252. The analysis 500 was carried out using the Finite Element Method (FEM).

Under the conventional V-bending technique where a workpiece (not shown) is not further shaped with various thickness distributions (i.e. has a uniform thickness), a large tensile stress and strain region typically develops in the outer layer of the workpiece at a portion where it has been bent (i.e. bent corner). The developed strain and stress subsequently cause cracking of the workpiece at the bent corner and may result in an undesirable large spring back effect thereat. Moreover. the workpiece is also being thinned at the portion during bending, and this thinning contributes to increased likelihood of cracking at the bent corner under the conventional V-bending technique. Needless to say, due to thinning of the bent corner, the coining deformation effected after bending (as performed in our method 100; see FIG. 2G) cannot be satisfactory carried out using the conventional V-bending technique.

However, for the enlarged portion 252 of FIG. 4A, it is sufficiently compressed along the dimension of its thickness by the coining deformation after bending is performed. This coining deformation accordingly generates high compressive stress and strain, as seen from the strain analysis in FIG. 5, in the bent enlarged portion 252 to prevent cracking. Correspondingly, from FIGS. 3, 4 and 5, it can be appreciated that the workpiece 104 is bent at the bumps 106 in a similar manner as the enlarged portion 252 of the metal piece 250 so that the bent portions is unlikely to crack during or after bending.

After Step (E), if necessary, Step (F) is carried out to push the two arm members 110a, 110b further closer to each other to create a channel 114 therebetween and this may more clearly be seen from FIGS. 2H and 6. As depicted, the second sub-portions 1102 of each arm 110a, 110b are substantially parallel to each other to define the channel 114. The channel 114 is particularly dimensioned to receive a portion of the orthodontic archwire 600, the manner of receipt being such that the longitudinally axis of the entire orthodontic archwire 600 is transverse to that of the channel 114. Additionally, the channel 114 is also formed such that it is positioned directly above the pair of teeth members 112. When the portion of the orthodontic archwire 600 is fully received within the orthodontic bracket 102, the portion of the archwire 600 is secured in position using the pair of teeth members 112, which cooperatively grip onto a lower half portion of the orthodontic archwire 600 as shown in FIG. 6. This ensures that the orthodontic archwire 600 is not held within the orthodontic bracket 102 in a loose arrangement, which may cause discomfort for a user and more importantly, does not enable the desired correction of the user's dental conditions to be carried out effectively. It will therefore be appreciated that the positioning of the teeth members 112 on the base member 108 are aligned with the channel 114 so that the orthodontic archwire 600 may easily be secured in place after insertion into or for subsequent removal from the orthodontic bracket 102.

Therefore, the finished workpiece 104 forms the orthodontic bracket 102, and generally resembles an asymmetrical inverted T-shaped member, when being rested on the base member 108 as depicted in FIG. 6. This also means that the orthodontic bracket 102 has an inverted T-shaped volume that is defined and enclosed by the base member 108, and the first and second arm members 110a, 110b.

Further, in this configuration, the bent arm members 110a, 110b are resiliently biased to part (or elastically deformed) slightly so that the portion of the orthodontic archwire 600 is insertable into the channel 114 and frictionally held by the arm member 110a, 110b before being secured by the teeth members 112, and is also subsequently removable from the orthodontic bracket 102 through the channel 114, when necessary. The resiliency of the arm members 110a, 110b is aided by the low Young's modulus of the titanium alloy which bestows elastically deformable characteristics to the orthodontic bracket 102, in particular to the first and second arm members 110a, 110b. Consequently, a series of orthodontic brackets 102, produced using the method 100 of the present embodiment, when worn by a patient would feel less irritable as they are more flexible (i.e. softer), as opposed to conventional orthodontic brackets which are bulky, rigidly configured, and typically formed of stainless steel.

Advantages of using the method 100 of FIG. 1 to produce the orthodontic bracket 102 include:

(1) enabling formation of the orthodontic bracket 102 from metal alloys characterised by low Young's modulus, without having the finished product suffer from cracking or reduced thickness at the corner portions due to the bending process.

(2) facilitating formation of the profile of the channel 114 in a manner so as to precisely control the dimensions of the channel 114, for receiving or removing orthodontic archwire, as well as for other convex or concave profiles of the orthodontic bracket 102, without involving unnecessary manufacturing steps; and

(3) allowing the spring-back effect of the workpiece 104 to be controlled more easily during the bending step, which is also further minimised by the coining process.

In all, the method 100 presents a high precision and economical manufacturing process (i.e. high production output, reduced material wastage and lower costs) for producing the orthodontic bracket 102 from materials (e.g. titanium alloy) with low Young's modulus.

Further, it has been found that the orthodontic bracket 102 produced from the method 100 is more comfortable to the patient as it is more flexible compared to conventional orthodontic brackets which is more rigid. Also, it was found, using the FEM analysis, that the insertion force required for pushing the orthodontic archwire into the orthodontic bracket 102, formed using the method 100, has comparatively been lowered by approximately 64%, with reference to conventional stainless-steel type orthodontic brackets having similar geometrical dimensions.

The described embodiment is not to be construed as limitative. For example, although β-titanium alloy is used as the material of the workpiece 104, other suitable materials, with low Young's modulus, may also be used, for example stainless steel. In addition, the thickness of the workpiece 104 may be in any dimension between 0.4 to 0.6 millimetres. Further, other shaping processes may also be used during the pre-forming stages, i.e. Steps (B) and (C).

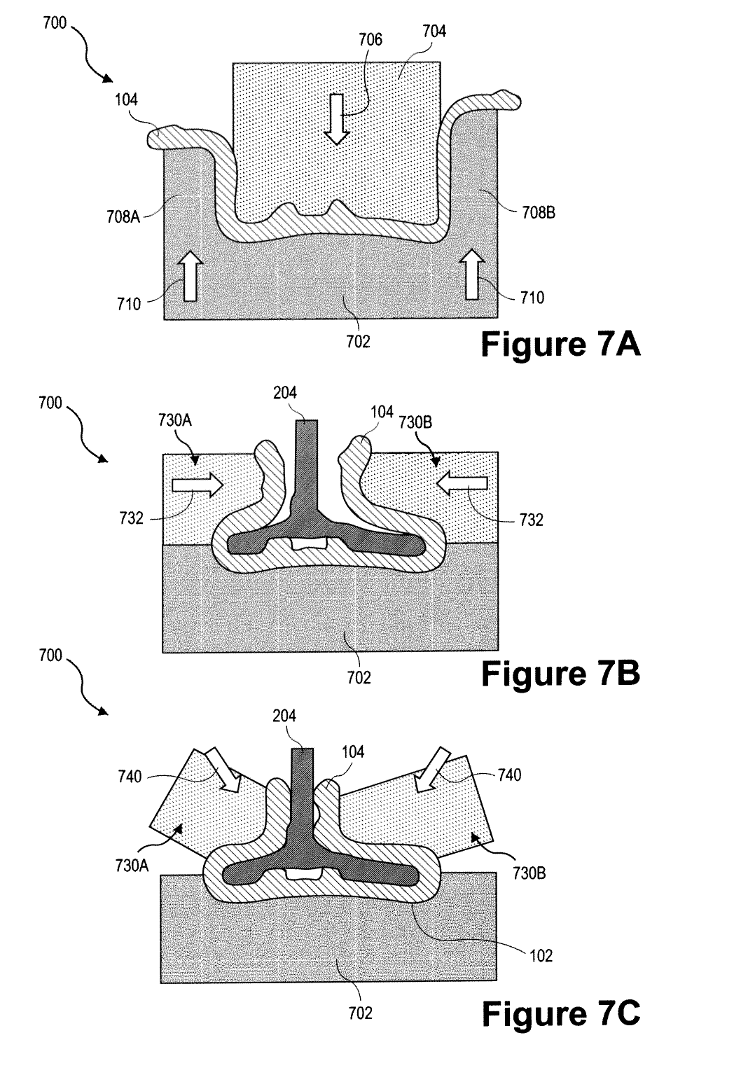

Yet according to another variation, the bending and coining stages of the method 100 may be performed using a modified Multi-slide Forming machine (MSF) 700 of FIGS. 7A to 7C, as opposed to the previously described tooling apparatus 2000 in FIGS. 2E to 2G. The definition of modified MSF 700 here means operating a conventional MSF together with a Computer Numerical Control (CNC) machine (not shown) to provide sufficient power to perform bending and coining to form the orthodontic bracket 102. In other words, the use with an additional CNC machine would then allow the MSF 700 to be operated to deliver the forces necessary to perform the bending and coining as required by the method 100 of FIG. 1.

In using the MSF 700, the workpiece 104 that has been shaped at Step (C) of the method 100 (as shown in FIG. 1), is first centrally positioned and clamped onto a base plate 702 of the MSF 700 as depicted in FIG. 7A. Thereafter, a top punch 704 is actuated towards the workpiece 104 in a direction (i.e. downwards) indicated by an arrow 706 to abut the workpiece 104 against the base plate 702. In this arrangement, the workpiece 104 is interposed between the top punch 704 and base plate 702. Next, two bottom punches 708a, 708b, lying on the same side as the base plate 702 and for engaging the arm members 110a, 110b of the workpiece 104, are moved upwards, in the direction indicated by arrows 710, to abut the arm members 110a, 110b, resulting in the arm members 110a, 110b being bent at around the respective bumps 106. At this stage, the workpiece 104 resembles the U-shaped member of Step (D) of FIG. 1. The top punch 704 and bottom punches 708m. 708b are then withdrawn, leaving the workpiece 104 clamped onto the base plate 702, before proceeding to the next stage.

In a subsequent stage shown in FIG. 7B, the mandrel tool 204 of FIG. 2F (II) is inserted and seated onto the U-shaped workpiece 104. Two side punches 730a, 730b are moved inwardly, as indicated by arrows 732, to engage and act on the vertically orientated arm members 110a, 110b using side forces. The side punches 730a, 730b are then further moved inward (towards each other), bending the arm members 110a, 110b about the bumps 106 by approximately 90°, whereby the U-shaped workpiece 104 consequently changes into a generally T-shaped workpiece 104 (i.e. Step (E) of FIG. 1). On completion of this stage, the side punches 730a, 730b are withdrawn, and at the last stage illustrated in FIG. 7C, the side punches 730a, 730b are re-applied to engage the arm members 110a, 110b in a manner such that the resultant forces delivered by the side punches 730a, 730b combinatory act on the arm members 110a, 110b from the top and inwardly. This bends the arm members 110a, 110b to form the channel 114, and the complete orthodontic bracket 102 is obtained (i.e. Step (F) of FIG. 1).

It will be appreciated that automated application of the punches 704, 708a, 708b, 730a, 730b to work the workpiece 104 are conducted sequentially, and eliminates the need to laboriously replace dies or tools (e.g. screwing and unscrewing). Advantageously, use of the MSF 700, in replace of the tooling apparatus 2000, enables mass production of the orthodontic bracket 102 to be efficiently carried out since there is no necessity to change dies in between the various stages, as the different punches 704, 708a, 708b, 730a, 730b are simply machine-operated to slide in/out for engagement, and withdrawn after use.

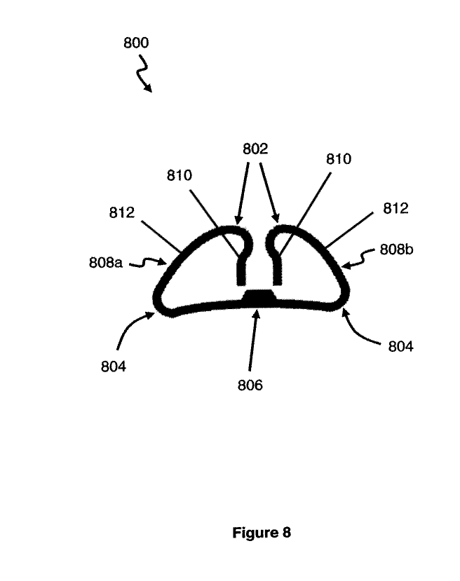

Additionally, the method 100 may also be adapted for forming other types of self-ligating type orthodontic brackets which have a similar structural arrangement (i.e. abase member intermediate two bumps and an arm member extending from each bump) as the orthodontic bracket 102 of FIG. 6. One such example is a second orthodontic bracket 800 depicted in FIG. 8. Specifically, the second orthodontic bracket 800 comprises two pairs of outer Zr and inner bumps 802, 804 that are bent and coined using the same techniques referred to in FIGS. 3A and 3B, which advantageously prevent cracking and the spring-back effect of the bent bumps 802, 804. It is to be appreciated that the inner and outer bumps 802, 804 are each shaped to be thicker than the thickness of the second orthodontic bracket 800 in its pre-form state. Before undergoing bending, the sequence of formation of the bumps 802, 804 on the bracket 800 (in its pre-form state) follows this order: outer-inner-inner-outer bumps 802, 804, 804, 802. In particular, a base member 806 is formed between the pair of inner bumps 804, while an arm member 808a, 808b extends from each inner bump 804. One outer bump 802 is then located on each arm member 808a, 808b, and consequently separates each arm member 808a, 808b into first and second sub-arm members 810, 812, in which the second sub-arm member 812 is connected to the inner bump 804 on one end. As apparent, the sequence for bending and coining the bumps 802, 804 would be first on the outer bumps 802, followed by the inner bumps 804. After the outer bumps 802 have been bent and coined, each pair of first and second sub-arm members 810, 812 is arranged to define an acute angle therebetween, as evident from FIG. 8. The inner bumps 804 are then bent and coined similarly as previously described in FIGS. 2E to 2G.

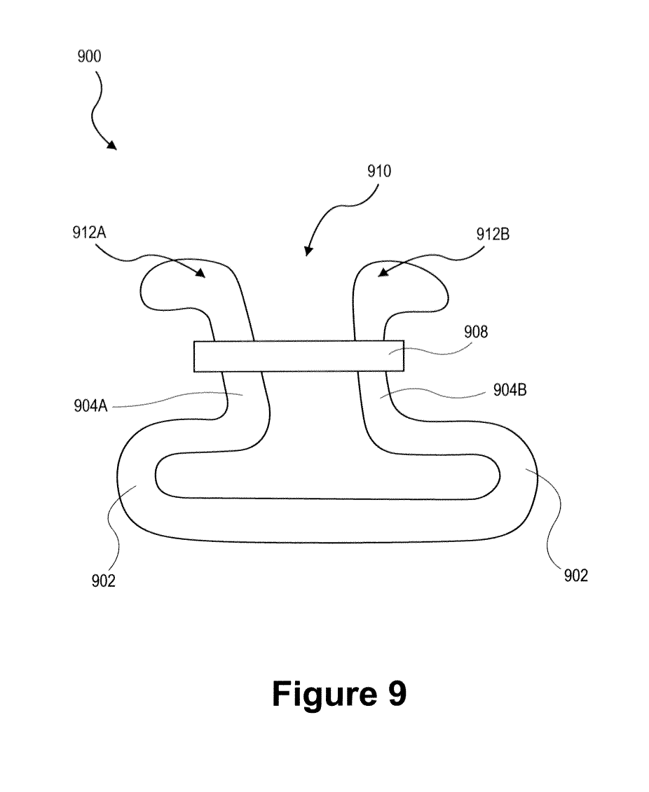

Moreover, the method 100 may also be employed to form certain types of non-self-ligating orthodontic brackets such as that shown in FIG. 9, in which bent portions 902 of a non-self-ligating orthodontic bracket 900 are similarly formed as the bent and coined bumps 106 of the orthodontic bracket 102 in FIG. 6. Particularly, the non-self-ligating orthodontic bracket 900 is arranged with a pair of arm members 904a, 904b that each extends from the respective bent portions 902 and cooperatively arranged as a T-shaped structure (similar to that in FIG. 6) to receive a portion of an orthodontic archwire (not shown) into the non-self-ligating orthodontic bracket 900. The arm members 904a, 904b are however not resiliently-biased to assist with the retention of the orthodontic archwire 906 within the non-self-ligating orthodontic bracket 900. Rather, an additional elastic band 908 (e.g. rubber band) is releasably fitted externally around the pair of arm members 904a, 904b to exert a restraining force urging them inwardly towards each other, so that the received portion of the orthodontic archwire does not slip out easily of the non-self-ligating orthodontic bracket 900 through the opening 910 formed at one end of the pair of arm members 904a, 904b. In addition, the elastic band 908 is prevented from being dislodged off the arm members 904a, 904b by means of a pair of outwardly projecting horizontal members 912a, 912b respectively formed at the free ends thereof. Further, the non-self-ligating orthodontic bracket 900 may be made of stainless steel, which has higher Young's modulus or higher rigidity compared to that of the material used to form the orthodontic bracket 102 of FIG. 6.

Alternatively described, there is described a method of forming an orthodontic bracket for use with an orthodontic archwire, the method comprising: shaping a length of material to form at least two enlarged portions and a base member, the base member being intermediate two arm members and the respective enlarged portions having a thickness that is thicker than the thickness of the base member; bending the length of material at the respective enlarged portions; and coining the respective enlarged portions, such that portions of the arm members define a channel to receive a portion of the orthodontic archwire. Each of the enlarged portions can be bent and coined to form a corner radius that is smaller than three times the thickness of the base member. The coining can be performed after the completion of the bending process or the coining is performed towards the completion of the bending process. The shaping can comprise metal stamping and cold forging the material. The portions of the arm members defining the channel can be configured to resiliently cooperate with each other for receiving the portion of the orthodontic archwire. The arm members can be configured to permit an elastic band to be releasably secured around the arm members for restraining the portion of the orthodontic archwire. The method can further comprise forming at least one locating feature on the base member to locate the portion of the orthodontic archwire. The material can be one having a modulus of elasticity in a range of between 40 to 60 GigaPascals (GPa). The material can one selected from the group consisting of a titanium-based alloy and a stainless steel. Also described is an orthodontic bracket formed using the aforedescribed method. The orthodontic bracket can be self-ligating or non-self-ligating.

Also described is an apparatus for forming an orthodontic bracket for use with an orthodontic archwire, the apparatus comprising: means for shaping a length of material to form at least two enlarged portions and a base member, the base member being intermediate two arm members and the respective enlarged portions having a thickness that is thicker than the thickness of the base member; means for bending and coining the length of material at the respective enlarged portions, such that portions of the arm members define a channel to receive a portion of the orthodontic archwire. The apparatus can be such that the means for bending and coining are configured to form a corner radius at each of the enlarged portions, the corner radius being smaller than three times the thickness of the base member. The means for bending and coining can be configured such that the coining is performed after the bending, or such that the coining is performed towards the end of the bending. The means for shaping can comprise means for metal stamping and cold forging. The apparatus can include a Multi-slide Forming (MSF) machine being cooperatively operated with a Computer Numerical Control (CNC) machine.

While various embodiments been illustrated and described in detail in the drawings and foregoing description, such illustration and description are to be considered illustrative or exemplary, and not restrictive. Other variations to the disclosed embodiments can be understood and effected by those skilled in the art in practising the claimed invention.

1. A method of forming an orthodontic bracket for use with an orthodontic archwire, the method comprising:
shaping a length of material to form at least two enlarged portions and a base member, the base member being intermediate two arm members and the respective enlarged portions having a thickness that is thicker than the thickness of the base member;
bending the length of material at the respective enlarged portions; and
coining the respective enlarged portions, such that portions of the arm members define a channel to receive a portion of the orthodontic archwire.

2. The method of claim 1, wherein each of the enlarged portions is bent and coined to form a corner radius that is smaller than three times the thickness of the base member.

3. The method of claim 1, wherein the coining is performed after the completion of the bending.

4. The method of claim 1, wherein the coining is performed towards the completion of the bending.

5. The method of claim 1, wherein the shaping comprises metal stamping and cold forging the material.

6. The method of claim 1, wherein the portions of the arm members defining the channel are configured to resiliently cooperate with each other for receiving the portion of the orthodontic archwire.

7. The method of claim 1, wherein the arm members are configured to permit an elastic band to be releasably secured around the arm members for restraining the portion of the orthodontic archwire.

8. The method of claim 1, further comprising forming at least one locating feature on the base member to locate the portion of the orthodontic archwire.

9. The method of claim 1, wherein the material has a modulus of elasticity in a range of between 40 to 60 GigaPascals (GPa).

10. The method of claim 1, wherein the material is one selected from the group consisting of a titanium-based alloy and a stainless steel.

11. An orthodontic bracket formed using a method of forming the orthodontic bracket for use with an orthodontic archwire, the method comprising:
shaping a length of material to form at least two enlarged portions and a base member, the base member being intermediate two arm members and the respective enlarged portions having a thickness that is thicker than the thickness of the base member;
bending the length of material at the respective enlarged portions; and
coining the respective enlarged portions, such that portions of the arm members define a channel to receive a portion of the orthodontic archwire.

12. The orthodontic bracket of claim 11, wherein the orthodontic bracket is self-ligating.

13. The orthodontic bracket of claim 11, wherein the orthodontic bracket is non-self-ligating.

14. An apparatus for forming an orthodontic bracket for use with an orthodontic archwire, the apparatus comprising:
means for shaping a length of material to form at least two enlarged portions and a base member, the base member being intermediate two arm members and the respective enlarged portions having a thickness that is thicker than the thickness of the base member;
means for bending and coining the length of material at the respective enlarged portions, such that portions of the arm members define a channel to receive a portion of the orthodontic archwire.

15. The apparatus of claim 14, wherein the means for bending and coining are configured to form a corner radius at each of the enlarged portions, the corner radius being smaller. than three times the thickness of the base member.

16. The apparatus of claim 14, wherein the means for bending and coining are configured such that the coining is performed after the bending.

17. The apparatus of claim 14, wherein the means for bending and coining are configured such that the coining is performed towards the end of the bending.

18. The apparatus of claim 14, wherein the means for shaping comprises means for metal stamping and cold forging.

19. The apparatus of claim 14, wherein the apparatus includes a Multi-slide Forming (MSF) machine being cooperatively operated with a Computer Numerical Control (CNC) machine.
